(19) United States
(12) Patent Application Publication
(10) Pub. No.: US 2016/0189297 A1
(43) Pub. Date: Jun. 30, 2016

(54) DATASET GENERATION FOR SYSTEM BACKTESTING AND ANALYSIS

(71) Applicant: TRADING TECHNOLOGIES INTERNATIONAL INC., Chicago, IL (US)

(72) Inventor: Stephen P. DECKER, Naperville, IL (US)

(21) Appl. No.: 14/588,175

(22) Filed: Dec. 31, 2014

(51) Int. Cl. G06Q 40/04

(52) U.S. Cl. CPC G06Q 40/04

(57) ABSTRACT

A trading strategy may be backtested using modified datasets that include simulated market data. The modified datasets may be determined from datasets that include actual or synthetic market data. Each record in the modified datasets may be based on a record in the datasets that include the actual or synthetic market data. The modified datasets may include more records than the datasets based on the actual or synthetic market data to extend the amount of information that may be used for backtesting. A trading strategy may be applied to one or more modified datasets that include the simulated market data and a result of the trading strategy may be output.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Electronic trading systems may additionally be used to backtest and evaluate the performance of a trading strategy. Performance testing a trading strategy requires a dataset of time series data that simulates a given market or conditions in which the trading strategy is designed to operate. Obtaining a dataset of a length having a statistically meaningful number of trade signals to accurately and effectively perform backtesting is often a difficult and time consuming task.

To obtain the desired dataset old market data or randomly altered versions of the old data is often utilized for backtesting purposes. Market behavior may structurally change over time and old market data may inaccurately reflect the true behavior of a current or recent market. Additionally, datasets that are produced by randomly altering old market data introduces elements to the dataset that are not based on actual market data.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5A illustrates a dataset comprising actual market data.

FIG. 5B depicts an example of a chart for the actual market data from FIG. 5A.

FIG. 6 illustrates a dataset comprising a base record and offsets calculated based on actual market data.

FIG. 7A illustrates a reordered dataset comprising a base record and rearranged offsets.

FIG. 7B illustrates a modified dataset that includes simulated market data.

FIG. 7C depicts an example of a chart for the simulated market data of FIG. 7B.

FIG. 8 illustrates an example flow diagram for generating a modified dataset based on actual market data.

FIG. 9 illustrates a flow diagram for generating additional data records for a modified dataset.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Backtesting a trading strategy may include testing a trading strategy based on historical market data in one or more datasets to predict and/or estimate the performance of the trading strategy. Historical market data may include actual market data collected and/or observed in a market. The data may include bar data and/or tick data. Bar data may include the opening price, the high price, the low price and the closing price for the tradeable object for a set period of time. Tick data may include the change in price of a tradeable object for a set period of time or from trade to trade.

System, methods, and apparatus are described herein for generating modified datasets that are based on actual or synthetic market data for backtesting a trading strategy. Each record in the modified datasets may be based on a record in the datasets that includes the actual or synthetic market data. A computing device may receive a time series dataset that includes actual or synthetic market data. An example of a time series dataset is shown in Table 1.

TABLE 1
Original Dataset

| Date | Open | High | Low | Close |
|---|---|---|---|---|
| Jan. 1, 2015 | 125 | 130 | 123 | 127 |
| Jan. 2, 2015 | 128 | 135 | 127 | 132 |
| Jan. 3, 2015 | 130 | 131 | 120 | 121 |
| Jan. 4, 2015 | 122 | 122 | 114 | 115 |
| . . . | . . . | . . . | . . . | . . . |

A modified dataset that includes simulated market data may be determined from the dataset that includes the actual or synthetic market data by determining a base record from the dataset that includes the actual or synthetic market data and generating offsets for the other data records. The base record may be the first or the last record in the dataset, for example. The offsets for each data record may be calculated from a price value (e.g., a tick value for tick data or a closing price value for bar data) of a prior or subsequent data record in the dataset, starting with the base record. The calculation of the offsets may be shown in Table 2.

TABLE 2
Dataset with Offsets

| Date | Open | High | Low | Close |
|---|---|---|---|---|
| Jan. 1, 2015 | 125 | 130 | 123 | 127 |
| Jan. 2, 2015 | +1 | +8 | 0 | +5 |
| Jan. 3, 2015 | −2 | −1 | −12 | −11 |
| Jan. 4, 2015 | +1 | +1 | −7 | −6 |
| . . . | . . . | . . . | . . . | . . . |

The data records including the offsets may be reordered to generate a randomized dataset, as shown in Table 3, for example.

TABLE 3
Randomized Dataset with Offsets

| Record | Open | High | Low | Close |
|---|---|---|---|---|
| Jan. 1, 2015 | 125 | 130 | 123 | 127 |
| Jan. 3, 2015 | −2 | −1 | −12 | −11 |
| Jan. 2, 2015 | +1 | +1 | −7 | −6 |
| Jan. 4, 2015 | +1 | +8 | 0 | +5 |
| . . . | . . . | . . . | . . . | . . . |

The price values of the modified dataset may be determined, for example, by applying the offsets to the price value (e.g., tick value or the closing price value) of a prior or subsequent data record, starting with the base record. Table 4 shows an example of a modified dataset that include price values that may be calculated by applying the offsets of each data record in Table 3 to the calculated closing price value of a prior data record in the dataset, starting with the base record.

TABLE 4
Modified Dataset with Simulated Market Data

| Record | Open | High | Low | Close |
|---|---|---|---|---|
| Jan. 1, 2015 | 125 | 130 | 123 | 127 |
| Jan. 2, 2015 | 125 | 126 | 115 | 116 |
| Jan. 3, 2015 | 117 | 117 | 109 | 110 |
| Jan. 4, 2015 | 111 | 118 | 110 | 115 |
| . . . | . . . | . . . | . . . | . . . |

Additional records for the modified dataset and/or additional modified datasets may be calculated based on the actual or synthetic market data as described herein. A trading strategy may be applied to one or more modified datasets that include the simulated market data and an output of the trading strategy may be analyzed and/or displayed to a user.

### I. Brief Description of Certain Embodiments

Systems, methods, and apparatus are described herein for determining data records for backtesting a trading strategy. As described herein, a computing device may receive market data that may be representative of a market for at least one tradeable object offered at one or more electronic exchanges. The market data may include a plurality of data records in a dataset. The computing device may define a base record from the plurality of data records. The computing device may determine at least one offset between a first data record of the plurality of data records and a second data record of the plurality of data records. The computing device may determine a modified dataset. The modified dataset may include the base record and a plurality of modified data records that include simulated market data. At least one modified data record of the plurality of modified data records may be based on the at least one offset determined from the first data record and the second data record of the plurality of records in the dataset. The computing device may analyze an output of a trading strategy in response to the modified data records of the modified dataset.

The at least one offset may include a plurality of offsets. The second data record of the plurality of data records may be subsequent to the first data record of the plurality of data records. The at least one offset may be based on a fixed relationship between the second data record and the first data record.

The modified dataset may be determined based on a randomized set of offsets between data records in the dataset. The randomized set of offsets may include the at least one offset.

Additional data records may be determined for the modified dataset. The additional records may be based on the base record and additional offsets. Each additional data record of the modified dataset may be determined based on at least one offset of the additional offsets.

The market for which the market data may be representative may be a real market or a synthetic market. The one or more electronic exchanges may include a plurality of electronic exchanges. The base record may be a first record or a last record of the plurality of data records in the dataset.

Each data record of the plurality of data records in the dataset and each modified data record of the plurality of modified data records in the modified dataset may include bar data or tick data. The bar data for the plurality of data records may include an opening price value, a high price value, a low price value, and a closing price value. The at least one offset between the first data record and the second data record in the dataset may be determined by determining a difference between the closing price value for the first data record in the dataset and the opening price value, the high price value, the low price value, and the closing price value for the second data record in the dataset.

Each data record of the dataset is associated with a volume level. The at least one offset between the first data record and the second data record may include an offset between the volume level associated with the first data record and the volume level associated with the second data record.

The plurality of data records in the dataset may include the market data for a time period. The plurality of modified data records in the modified dataset includes the simulated market data for the same time period.

The modified dataset may be displayed by a computing device. A chart that is based on the modified dataset may be displayed by a computing device.

A computing device may apply a trading strategy to the modified dataset. The trading strategy may be associated with a tradeable object. A result of the trading strategy may be determined and/or the result of the trading strategy may be displayed on a computing device.

### II. Example Electronic Trading System

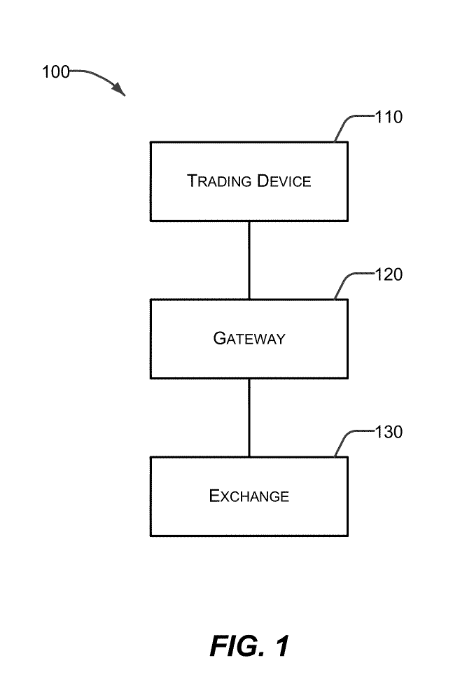

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

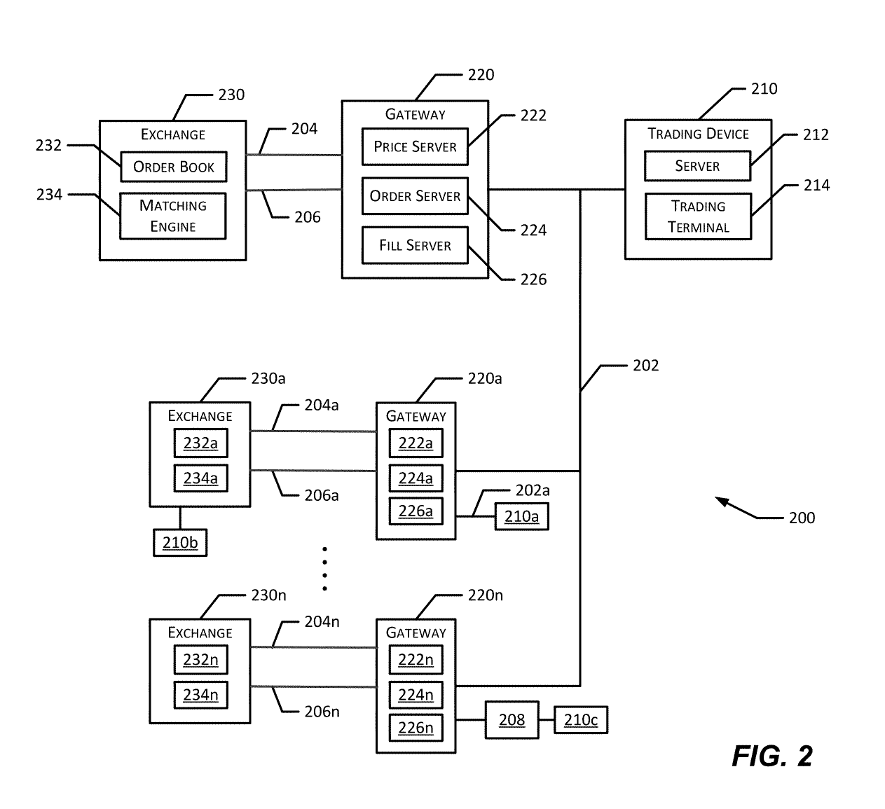

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

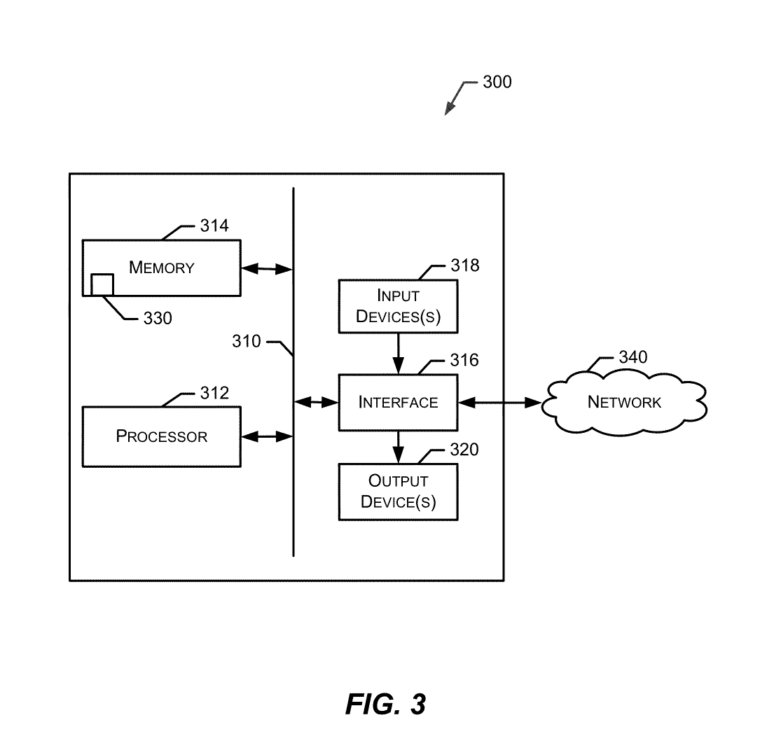

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

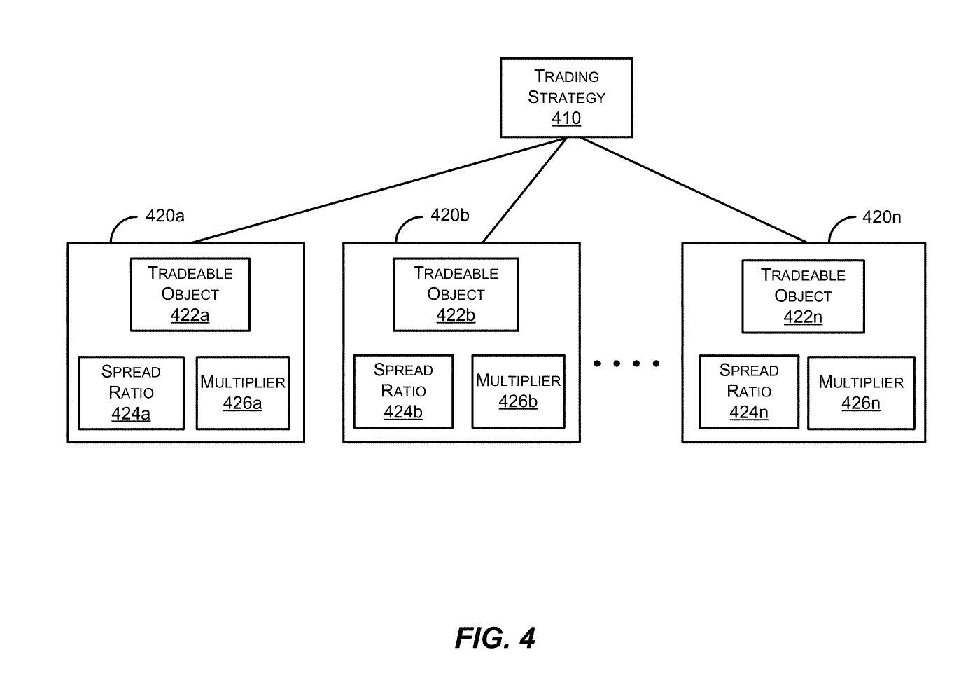

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Dataset Generation for System Backtesting and Analysis

A system and method for generating time series datasets for backtesting from actual market data may include a computing device capable of receiving actual market data from one or more markets and calculating market data that may reflect actual bar ranges that occurred in a real market. The disclosed system and method provides a mechanism by which the generated time series dataset represents actual bar ranges that occur in the real market. The disclosed mechanism provides simulated datasets that include bar ranges reflective of the volatility present in the actual bar ranges. Backtesting a trading strategy may include applying a trading strategy to an existing historical dataset comprising time series data. Historical data may include actual data collected and/or observed in a market. The data may include bar data and/or tick data.

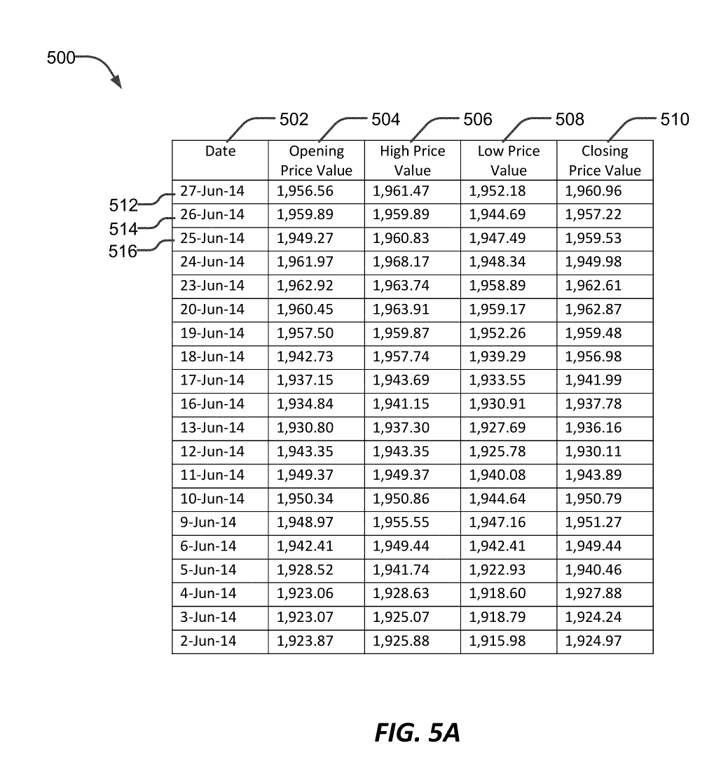

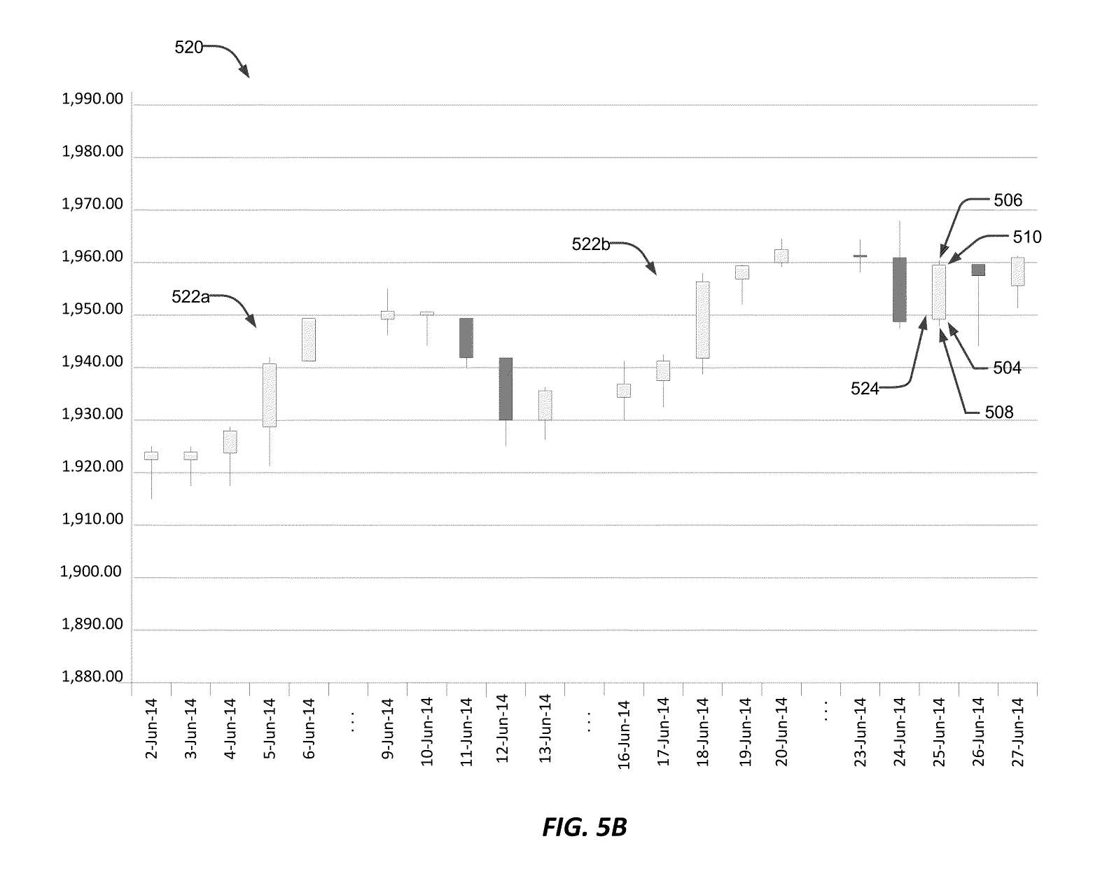

FIG. 5A illustrates a dataset 500 comprising market data arranged and formatted into bar data which may be utilized by certain disclosed embodiments. The illustrated dataset 500 represents actual or real market data generated via trading activities at one or more electronic exchanges. The dataset 500 may be determined and/or displayed at a computing device. For example, the dataset 500 may be determined and/or displayed via a trading application that may be run at a computing device. The dataset 500 may include actual market data for a tradeable object. The actual market data may be time series data included in multiple data records. For example, a time increment 502 may be associated with one or more data records. The time increment 502, as shown in FIG. 5A, is listed in dates or days. The time increment 502 may be any time increment, such as thirty minutes, one hour, two hours, six hours, twelve hours, one week, etc. The plurality of data records include bar data. Bar data may comprise the opening price value 504, the high price value 506, the low price value 508 and/or the closing price value 510 for the tradeable object for the time increments 502. The data record may comprise tick data. Tick data may comprise the change in price of a tradeable object for a set period of time or from trade to trade.

FIG. 5B illustrates a chart 520 of the actual market data organized into the dataset 500 from FIG. 5A. The chart 520 may be generated and/or displayed at a computing device. For example, the chart 520 may be generated and/or displayed via a trading application that may be run at a computing device. The chart 520 reflects market trends in the market data. The chart 520 is a graphical representation of the bar data, comprising the opening price value 504, the high price value 506, the low price value 508, and the closing price value 510 for the tradeable object for the data records in the dataset 500. In the chart 520, the bar data for each record in the dataset 500 is indicated with a candlestick price bar. The top and bottom of the thin vertical line, or upper and lower shadow, of each candlestick price bar represent the high price value 506 and the low price value 508, respectively, for a data record. The opening price value 504 and the closing price value 510 for a data record are indicated in the real body of the candlestick price bar.

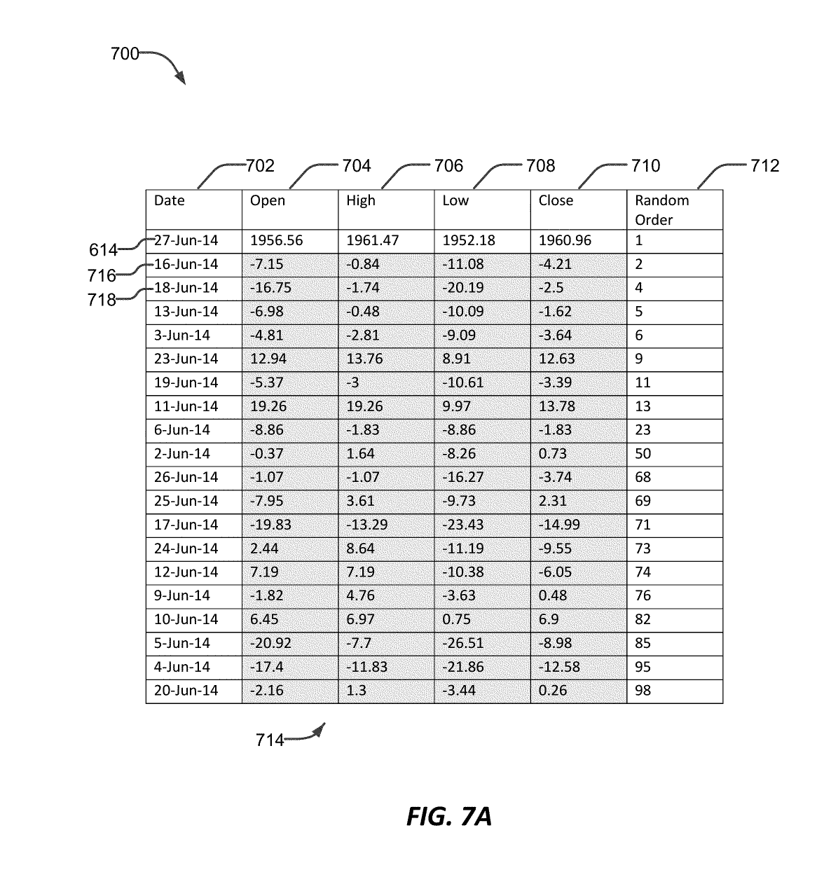

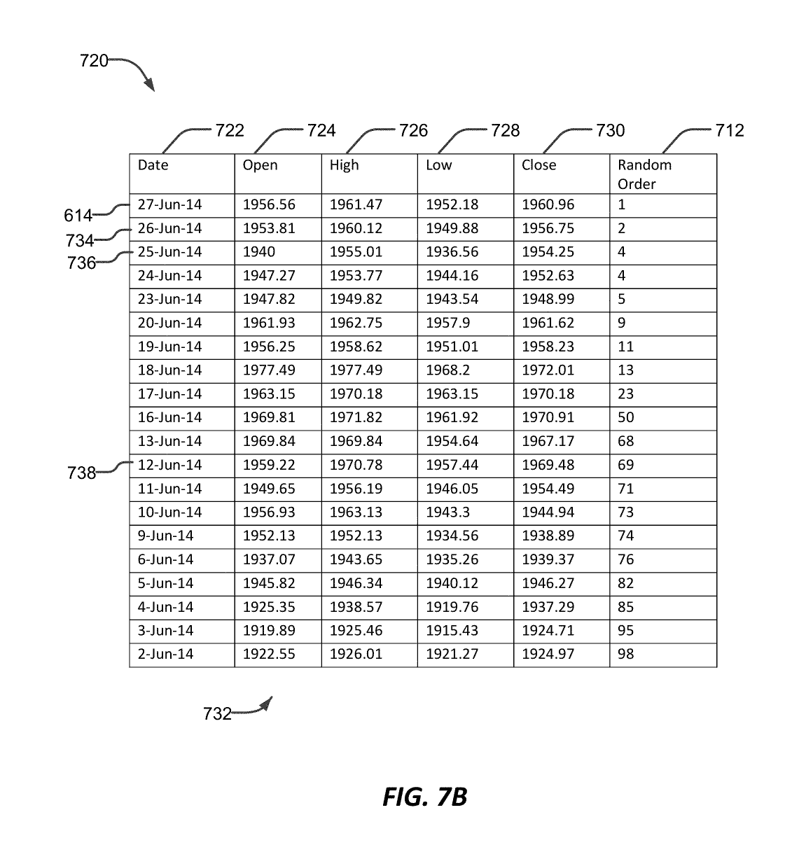

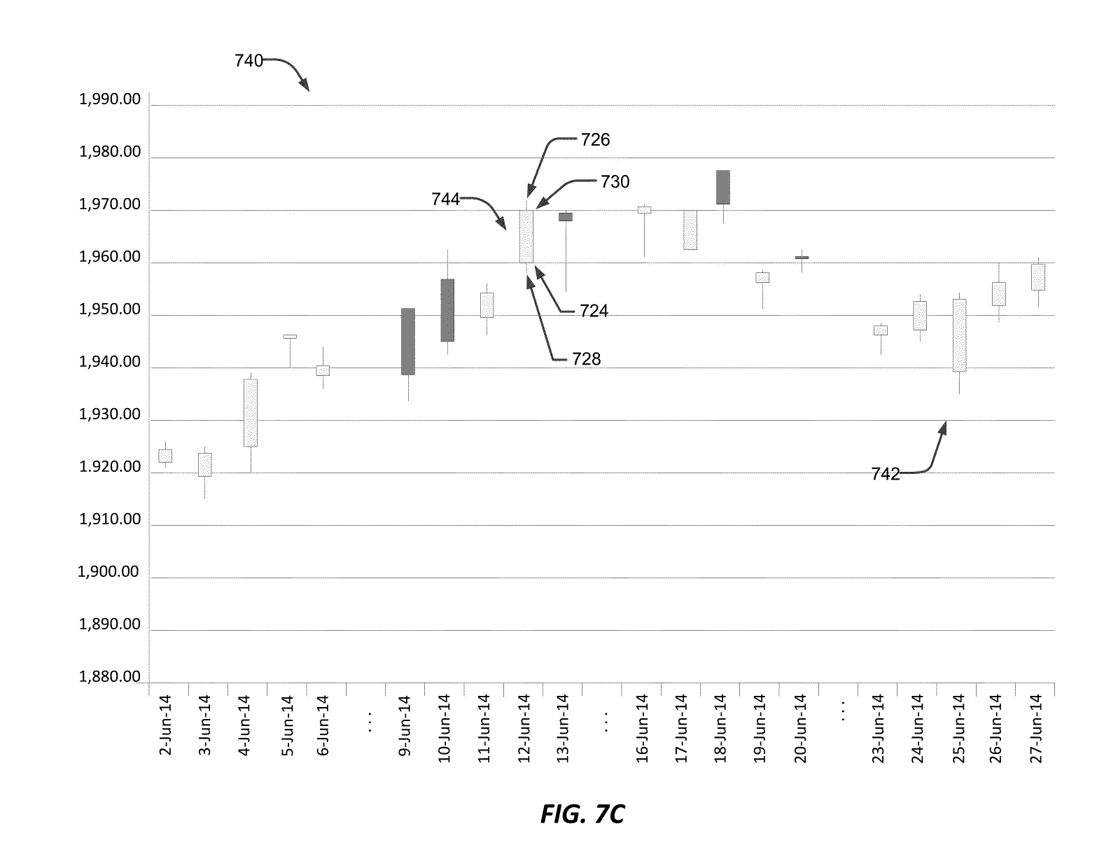

In an example, the candlestick price bar 524 represents the bar data in data record 516 in the dataset 500 illustrated in FIG. 5A. The candlestick price bar 524 indicates the opening price value 504 of 1,949.27 for the data record 516 at the bottom of the real body. The candlestick price bar 524 indicates the high price value 506 of 1,960.83 for the data record 516 at the top of the upper shadow. The candlestick price bar 524 indicates the low price value 508 of 1,947.49 for the data record 516 at the bottom of the lower shadow. The candlestick price bar 524 indicates the closing price value 510 of 1,959.53 for the data record 516 at the top of the real body. Thus, the candlestick price bar 524 represents an actual bar that occurred in the real market. The candlestick price bar 524, as well as one or more other price bars in the chart 520, may be retained in a simulated dataset that has different price values and trends, as illustrated in FIGS. 7B and 7C for example. The advantage of this proposed method is that each bar in the transformed dataset will represent an actual bar that occurred in the real market. With this approach the resultant simulated datasets will include bar ranges of volatility that represent what has actually occurred in the past.

The chart 520 may indicate increases and/or decreases in price values over the course of the time increments 502. The real body of the candlestick for a data record may be darker in color to indicate the closing price value 510 being lower than the opening price value 504. The real body of the candlestick for a data record may be lighter in color to indicate the closing price value 510 being higher than the opening price value 504. If the closing price value 510 is higher than the opening price value 504, the market experienced an increase during the time increment 502 associated with the data record. If the closing price value 510 is lower than the opening price value 504, the market experienced a decrease during the time increment 502 associated with the data record. The chart 520 illustrates market trends, such as uptrends in the market 522a, 522b. Downtrends in the market may also, or alternatively, be illustrated in the chart 520. While the chart 520 indicates bar data that may be indicated with candlestick price bars, the chart 520 may indicate tick data that may be otherwise represented.

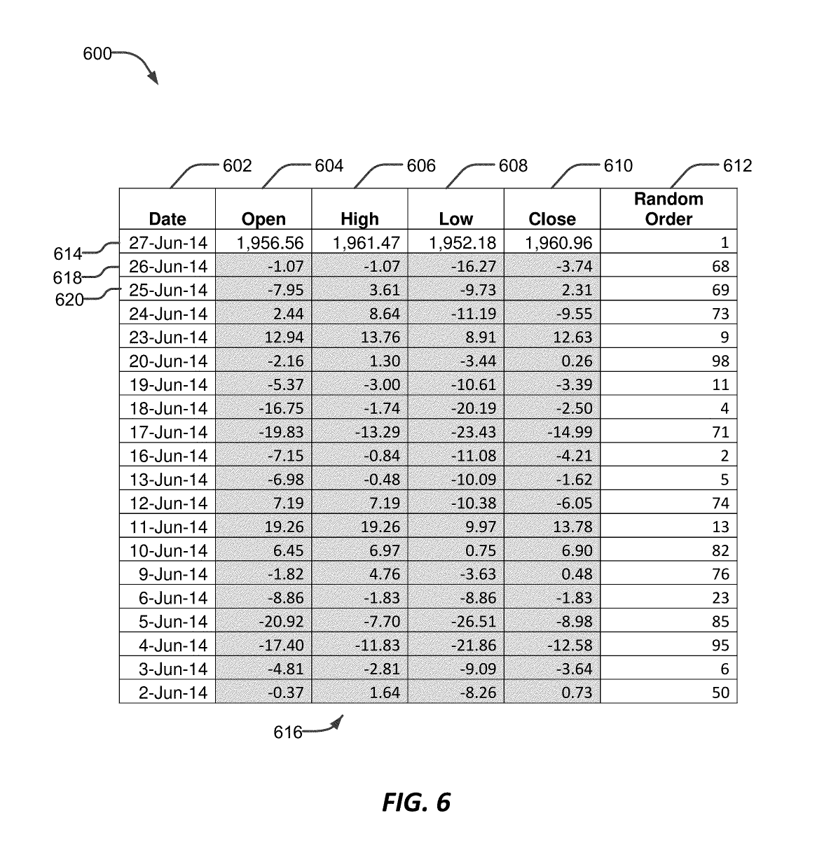

FIG. 6 illustrates a dataset 600 that may be calculated from the dataset 500. The dataset 600 may be calculated and/or displayed at a computing device. For example, the dataset 600 may be calculated and/or displayed via a trading application that may be run at a computing device. The dataset 600 may include data records (e.g., data records such as records 614, 618 and 620) that have time increments 602 that correspond to the time increments 502 in the dataset 500. The time increment 602 may be measured by any increment of time. The data records in the dataset 600 may include the opening price value 604, the high price value 606, the low price value 608, the closing price value 610, and/or a randomly assigned number 612 for the tradeable object for a time increment 602.

The dataset 600, illustrated in FIG. 6, may include abuse record 614 and/or a number of offsets 616 that may be calculated from the actual market data in the dataset 500, illustrated in FIG. 5A. The base record 614 may be preserved from the dataset 500. For example, the opening price value 604, the high price value 606, the low price value 608, and/or the closing price value 610 of the base record 614 may correspond to the opening price value 504, the high price value 506, the low price value 508, and/or the closing price value 510, respectively, for a data record 512 (e.g., the Jun. 27, 2014 data record) in the dataset 500. When tick data is used, the base record 614 may include the same tick data as the tick data for the corresponding data record in the dataset that includes the actual market data.

In the dataset 600, the offsets 616 may be calculated for the opening price value 604, the high price value 606, the low price value 608, and/or the closing price value 610 for each data record other than the base record. The offsets 616 may be calculated from the actual market data records in the dataset 500. For example, the offsets 616 may be calculated by subtracting the values for records in the dataset 500 from corresponding data records in a previous time increment to determine an offset between the values. When bar data is used, the offsets 616 may be calculated by subtracting the closing price value in the data record fora subsequent time increment from the opening price value, the high price value, the low price value, ad/or the closing price value in a data record for a previous time increment in the dataset 500. When tick data is used, the offsets may be calculated by subtracting the tick price value for a subsequent time increment from the tick price value in a previous time increment.

In an example, in the dataset 500 the opening price value 504 for the data record 514 is 1,959.89. The closing price value 510 of the previous data record 512 in the dataset 500 is 1,960.96. The opening price value 504 for the data record 514 may be subtracted from the closing price value 510 of the subsequent data record 512 in the dataset 500 resulting in a calculated offset of −1.07. The data record 512 has a time increment that is later in time than the data record 514. The offset value of −1.07 may be the offset for the opening price value 604 of the data record 618 in the dataset 600.

The offset of the high price value 606, the low price value 608, and/or the closing price value 610 for the data record 618 may be similarly calculated by subtracting the high price value 506, the low price value 508, and/or the closing price value 510 in the corresponding data record 514 from the closing price value 510 in the subsequent data record 512 in the dataset 500. For example, the high price value 506 for the data record 514 (e.g., 1,959.89) may be subtracted by the closing price value 510 of the data record 512 in the dataset 500 (e.g., 1,960.96). The resulting offset value of the subtraction from the high price value 506 for the data record 514 (e.g., −1.07) may be the offset for the high price value 606 of the data record 618 in the dataset 600. The low price value 508 for the data record 514 (e.g., 1,944.69) may be subtracted by the closing price value 510 of the data record 512 in the dataset 500 (e.g., 1,960.96). The resulting offset value of the subtraction from the low price value 508 for the data record 514 (e.g., −16.27) may be the offset for the low price value 608 of the data record 618 in the dataset 600. The closing price value 510 for the data record 514 (e.g., 1,957.22) may be subtracted by the closing price value 510 of the data record 512 in the dataset 500 (e.g., 1,960.96). The resulting offset value of the subtraction from the closing price value 510 for the data record 514 (e.g., −3.74) may be the offset for the closing price value 610 of the data record 618 in the dataset 600.

The offsets 616 for the data record 620 may be calculated by subtracting the price values in a corresponding data record 516 in the dataset 500 from the closing price value for a data record that has a subsequent time increment 502, such as the data record 514. For example, the opening price value 504, the high price value 506, the low price value 508, and/or the closing price value 510 of the data record 516 may be subtracted by the closing price value 510 of the data record 514 to calculate the offsets 616 in the data record 620. The offsets 616 for each data record in the dataset 600 may be calculated in a similar manner based on the actual market data in the dataset 500. While the examples described herein may calculate the offsets for each data record using a price value from the data record that is next in time in the dataset, the offsets may be calculated from data records that are later in time and/or data records that are earlier in time. In certain embodiments the offset calculation may be based on, for example, a percentage difference between two or more values. Percentage difference calculations may be utilized in situations where the price values include significant variation. The percentage difference calculations may serve to normalize the calculated offsets such that each bar calculated based on the offset data reflects the difference relative to the previous offset and/or bar from which it was derived.

The data records comprising the calculated offsets 616 may each be assigned a random number 612. The base record 614 may be assigned a static number (e.g., the first or last data record) from which the other data records may be reordered, while the remaining records may be randomly assigned numbers. The data records may be reordered according to the random numbers assigned to each record. For example, the data records may be reordered from the smallest random number to the greatest random number, from the greatest random number to the smallest random number, or using another reordering scheme. The reordering of the data records may generate a dataset that includes the base record 614, which includes the price values of the data record from the actual market data in the dataset 500, and a randomized set of data records, which may each include one or more offsets 616 that are based on the actual market data in the dataset 500. When tick data is used, the base record 614 may include a price value that may indicate a change in price of a tradeable object for a set period of time or from trade to trade and the offsets 616 may indicate a difference between data records that include tick data based on actual market data.

While the offsets 616 are calculated by subtracting values in one data record from another, other calculations may be performed to generate a fixed relationship between data records in the dataset 500. For example, the fixed relationship may be indicated by a percentage. The results of the calculations may be randomized to generate a randomized dataset that is based on actual market data.

FIG. 7A illustrates a dataset 700 that includes a reordered version of the dataset 600, illustrated in FIG. 6. The dataset 700 may be determined and/or displayed at a computing device. For example, the dataset 700 may be determined and/or displayed via a trading application that may be run at a computing device. The dataset 700 includes the base record 614 from the dataset 600 and the offsets 714. As shown in FIG. 7A, the offsets 714 may be a reordered version of the offsets 616 from the dataset 600. The data records in the dataset 600 may be reordered in the dataset 700 according to the random number 612 assigned to each data record to generate the reordered offsets 714.

The data records in the dataset 700 may include the opening price value 704, the high price value 706, the low price value 708, the closing price value 710, and the randomly assigned numbers 712 for the tradeable object for the time increments 702. The randomly assigned numbers 712 for the records may be a reordered version of the randomly assigned numbers 612. While the time increment 702 is a day in the dataset 700, the time increment 702 may be measured by any increment of time. In the dataset 700, the base record 512, 614 may be preserved from the actual market data. The reordered offsets 714 in the dataset 700 may also be based on the actual market data. The reordered offsets 714 may be used to generate a randomized set of data records that are based on the actual market data in the dataset 500.

FIG. 7B illustrates a dataset 720 that may be computed using the dataset 700 of FIG. 7A. The dataset 720 may be calculated and/or displayed at a computing device. For example, the dataset 720 may be calculated and/or displayed via a trading application that may be run at a computing device. The dataset 720 may be a modified dataset of the dataset 500 that includes the actual market data. The dataset 720 may include data records that have simulated market data 732 that is based on the actual market data. The simulated market data 732 for each data record may include bar data that includes a simulated price value for the opening price value 724, the high price value 726, the low price value 728, and/or the closing price value 730 for the tradeable object for a time increment 722. While the time increment 722 is a day in the dataset 720, the time increment 722 may be measured by any increment of time. Additionally, while the simulated market data 732 is represented as bar data in the dataset 720, the simulated market data 732 may be represented as tick data. When tick data is used, the simulated price values may include simulated tick values.

In the dataset 720, the base record 614 may be preserved from the dataset 600. This may include the preservation of the time increment 722 for the base record 614. The time increments 722 for the other records may be reordered from the time increments 702 in the dataset 700. The time increments 722 may be reordered independent of the other data in each data record. The time increments 722 may be reordered in an ascending or descending order, for example, to simulate an actual market.

The simulated market data 732 for each data record in the dataset 720, illustrated in FIG. 7B, may be calculated using the reordered offsets 714 in the dataset 700, illustrated in FIG. 7A. For example, the simulated market data 732 may be calculated by applying the reordered offsets 714 for each data record to a price value (e.g., simulated or actual market value). When bar data is used, the simulated market data 732 may be calculated by applying each offset to a closing price value in another data record, such as a previous data record according to the random order 712, for example. When tick data is used, the simulated market data may be calculated by applying each offset to a tick value in another data record, such as a previous data record according to the random order, for example.

In an example, referring to the dataset 700, the offset of the opening price value 704 for the data record 716 (e.g., −7.15) may be added to the closing price value 710 of the base record 614 (e.g., 1960.96). The resulting opening price value (e.g., 1953.81) may be included in the simulated opening price value 724 for the data record 734 in dataset 720. Referring again to the dataset 700, the offset of the high price value 706 for the data record 716 (e.g., −0.84) may be added to the closing price value 710 of the base record 614 (e.g., 1960.96). The resulting high price value (e.g., 1960.12) may be included in the simulated high price value 726 for the data record 734 in dataset 720. The offset of the low price value 708 for the data record 716 in the dataset 700 (e.g., −11.08) may be added to the closing price value 710 of the base record 614 (e.g., 1960.96). The resulting low price value (e.g., 1949.88) may be included in the simulated low price value 728 for the data record 734 in dataset 720. The offset of the closing price value 710 for the data record 716 in the dataset 700 (e.g., −4.21) may be added to the closing price value 710 of the base record 614 (e.g., 1960.96). The resulting closing price value (e.g., 1956.75) may be included in the simulated closing price value 730 for the data record 734 in dataset 720.

The other data records in the dataset 720 may be calculated by applying each offset in the corresponding data record in the dataset 700 to a simulated closing price value 730 in another data record. The simulated closing price value 730 to which an offset is applied may be the previous data record according to the random order 712. For example, for the data record 718 in the dataset 700, the offset of the opening price value 704 (e.g., −16.75), the offset of the high price value 706 (e.g., −1.74), the offset of the low price value 708 (e.g., −20.19), and/or the offset of the closing price value 710 (e.g., −2.5) may be added to the simulated closing price value of the data record 734 in the dataset 720 (e.g., 1956.75). The resulting values may be included in the data record 736 in the dataset 720 as the simulated open price value 724 (e.g., 1940), the simulated high price value 726 (e.g., 1955.01), the simulated low price value 728 (e.g., 1936.56), and/or the simulated closing price value 730 (e.g., 1954.25), respectively. While the examples described herein may apply the offsets for each data record to a price value of a data record having the immediately preceding random number in the dataset, the offsets may be calculated from data records that are earlier in the random order and/or data records that are later in the random order.

The bar data for each data record in the dataset 720 may be relatively similar to the bar data of a corresponding record in the dataset 500 illustrated in FIG. 5. As the bar data for each data record in the dataset 720 may be determined using offsets that are determined from the bar data of the actual market data in the dataset 500, the relative difference between the price values 724, 726, 728, and 730 for a data record in the dataset 720 may be the same as the relative difference between the price values 504, 506, 508, 510 for a corresponding data record in the dataset 500. While the relative difference between the price values 724, 726, 728, and 730 for a data record in the dataset 720 may be the same as the relative difference between the price values 504, 506, 508, 510 for a data record in the dataset 500, the actual price values 724, 726, 728, 730 for the bar data in each record in the dataset 720 may be different from the actual price values 504, 506, 508, 510 in the dataset 500. The time increment for the data record in the dataset 720 may also, or alternatively, be different from the time increment for the data record in the dataset 500. As an example, the data record 738 in the dataset 720 may include bar data with price values 724, 726, 728, and 730 that have the same relative difference as the price values 504, 506, 508, 510 of the bar data for the data record 516 in the dataset 500.

FIG. 7C illustrates a chart 740 of the dataset 720 of FIG. 7B. The chart 740 may be generated and/or displayed at a computing device. For example, the chart 740 may be generated and/or displayed via a trading application that may be run at a computing device. The chart 740 may reflect market trends in the dataset 720. For example, the chart 740 represents an uptrend in a simulated market at 742 based on the data records in the dataset 720. The chart 740 may also, or alternatively, represent downtrends in the simulated market. The chart 740 is a graphical representation of the bar data, comprising the simulated opening price value 724, the simulated high price value 726, the simulated low price value 728, and the simulated closing price value 730 for the tradeable object for each of the data records in the dataset 720. In the chart 740, the bar data for each data record in the dataset 720 is indicated with a candlestick price bar. The top and bottom of the thin vertical line, or upper and lower shadow, of each candlestick price bar represent the high price value 726 and the low price value 728, respectively, for a data record in the dataset 720. The opening price value 724 and the closing price value 730 for a data record are indicated in the real body of the candlestick price bar.

In an example, the candlestick price bar 744 represents the bar data in data record 738 in the dataset 720 illustrated in FIG. 79. The candlestick price bar 744 indicates the opening price value 724 of 1,959.22 for the data record 738 at the bottom of the real body. The candlestick price bar 744 indicates the high price value 726 of 1,970.78 for the data record 738 at the top of the upper shadow. The candlestick price bar 744 indicates the low price value 728 of 1,957.44 for the data record 738 at the bottom of the lower shadow. The candlestick price bar 744 indicates the closing price value 730 of 1969.48 for the data record 738 at the top of the real body. Thus, the candlestick price bar 744 represents an actual bar that occurred in the real market, but that indicates simulated bar data based on the real market data.

The chart 740 may illustrate increases and/or decreases in the simulated market. The real body of the candlestick being lighter in color may indicate the simulated closing price value 730 being higher than the simulated opening price value 724, If the simulated closing price value 730 is higher than the simulated opening price value 724, the chart 740 may indicate an increase in the simulated market data during the time increment 722 for the data record. The real body of the candlestick being darker in color may indicate the simulated closing price value 730 being lower than the simulated opening price value 724. If the simulated closing price value 730 is lower than the simulated opening price value 724, the chart 740 may indicate a decrease in the simulated market data during the time increment 722 for the data record.

The chart 740 may illustrate that the bar data for each data record in the dataset 720 may be relatively similar to the bar data of a corresponding record in the dataset 500 illustrated in FIG. 5. For example, the candlestick price bar 744 may represent the data record 738 in the dataset 720. The candlestick price bar 744 indicates a similar relative distance between the opening price value, high price value, low price value, and closing price value as the candlestick price bar 524 shown in the chart 520 in FIG. 5B, which represents the price bar for the data record 516 in the dataset 500 to which the data record 738 may correspond. The candlestick price bar 744 indicates bar data that is relatively similar to the candlestick price bar 524, which represents actual market data, but the candlestick price bar 744 may represent different actual price values at a different time increment.

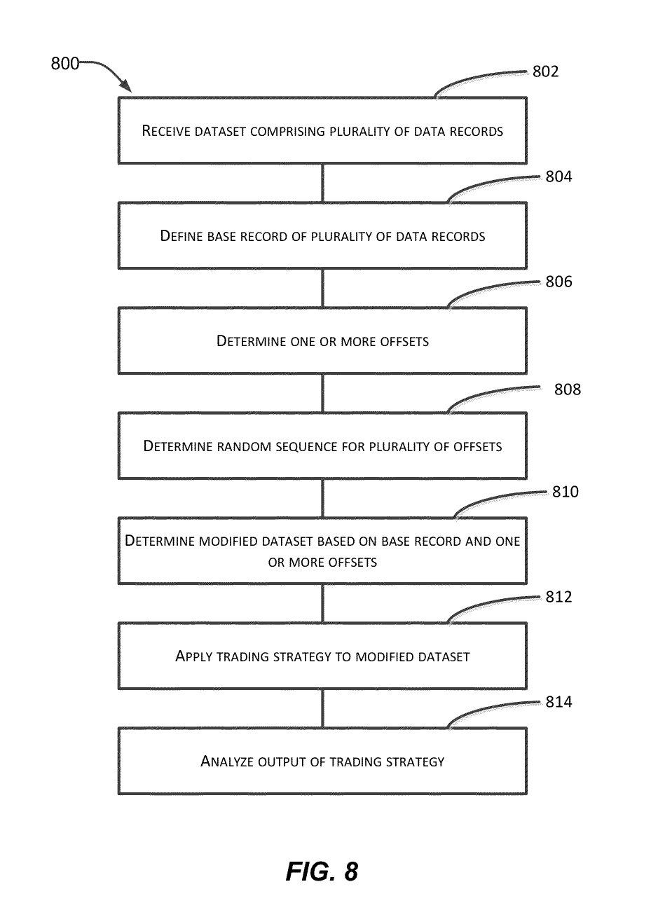

FIG. 8 illustrates a flow diagram of an example method 800 for generating a modified dataset. The method 800 may be performed by one or more computing devices, such as trading device 210 in FIG. 2, for example. As shown in FIG. 8, a computing device may receive a dataset that includes a plurality of data records at block 802. The data records may include actual market data for a time period. The market may be a synthetic market or a real market on which actual market data may be derived from previously traded objects on an electronic exchange. The data records may be obtained for the time period from the electronic exchange. The electronic exchange, and/or the gateway that may have access to the electronic exchange, may be selected by the user of the computing device or may be otherwise predetermined.

The time period from which the data records may be obtained may be selected by a user of a computing device or may be otherwise predetermined. The data records determined at block 802 may be sequential data records for the time period. Each data record may include market data for a different time increment over the time period. The time increments may be divided into any amount of time. For example, the time increments may be based on predetermine intervals, wherein the predetermined intervals are measured based on minutes, hours, days, weeks, years, etc.

The data records may include bar data or tick data. The data records that include bar data may each include an opening price, a high price, a low price, and a closing price. The data records that include tick data may each include a change in price of a tradeable object for a set period of time or from trade to trade. The data records may include a volume level. The volume level may indicate the volume of tradeable objects that may be exchanged for a time increment in a data record. Each data record may include a volume level indicated in the actual market data. Each data record may include bar data for one or more markets.

At block 804, a computing device may define a base record of the data records. The data records may be in a sequence that may be categorized based on time series information and/or time increments. For example, the base record may be sequentially the first data record in the sequence of data records, the second data record may be sequentially the second data record in the sequence, etc. The base record may be the last data record in the sequence of data records, the second data record may be the second to last data record in the sequence, etc. The base record may be a data record after the first data record and before the last data record in the sequence of data records, and the second data record may be the data record immediately subsequent to or preceding the base record. A modified sequence of data records (e.g., a simulated sequence of data records) may be determined using the base record.

At block 806, a computing device may determine one or more offsets between data records in the dataset (e.g., as described with respect to FIG. 6). For example, the computing device may calculate the offset between sequential data records in the dataset, beginning or ending with the base record. If the data records include bar data, the computing device may determine the offsets for each data record, other than the base record, by determining a difference between a closing price value of the bar data for a prior or subsequent data record and each of the opening price value, the high price value, the low price value, and/or the closing price value of the bar data for a prior or subsequent data record. If the data records include tick data, the offset for each data record, other than the base record, may be determined by taking a difference between a tick value for a data record and a tick value for a prior or subsequent data record. The data records that are used to calculate the offsets may be separated by a number of data records or may be adjacent data records.

The offset for the volume level of a data record may be determined based on the volume level of a prior or subsequent data record. For example, the volume level of a data record may be subtracted from the volume level of a prior or subsequent data record. The volume level of the base record may be the first volume level from which an offset may be determined.

When multiple markets are included in a data record, the offsets for each market may be determined based on a price value in the same market for a prior or subsequent data record. For example, if the data records include bar data, the computing device may determine the offsets for each data record, other than the base record, by determining a difference between a closing price value of the bar data for a prior or subsequent data record and each of the opening price value, the high price value, the low price value, and/or the closing price value of the bar data for a prior or subsequent data record in the same market. If the data records include tick data, the offset for each data record, other than the base record, may be determined by taking a difference between a tick value for a data record and a tick value for a prior or subsequent data record in the same market.

At block 808, a computing device may determine a random sequence for the one or more offsets calculated at block 806. The computing device may determine the random sequence by assigning each data record that includes an offset in the sequence a random number. The data records may be reordered according to the assigned random numbers. For example, the data records may be reordered in an ascending or descending order according to the assigned random number of each data record. The computing device may maintain the base record as a static record in the reordered sequence, such as a first record or a last record in the reordered sequence, for example. To maintain the base record as a static record in the reordered sequence, the base record may be assigned a dedicated number (e.g., the first number or last number in the sequence) rather than being assigned a random number.

At block 810, a computing device may determine a modified dataset based on the base record and the one or more offsets calculated at block 806. The modified dataset may include simulated market data that may be based on the actual market data for one or more tradeable objects that have been traded on an exchange. The modified dataset may be computed by applying the offsets to a previous or subsequent data record (e.g., as described with respect to FIG. 7B). For example, the computing device may apply the offsets of data record to a prior or subsequent price value in the dataset, beginning or ending with the base record for example, to determine a price value for the data record comprising the offset. The offsets may be applied sequentially to determine the modified dataset. If the data records include bar data, the computing device may apply the offsets for the opening price value, the high price value, the low price value, and/or the closing price value of each data record, other than the base record, to the closing price value that has been calculated for a prior or subsequent data record. If the data records include tick data, the offset for each data record, other than the base record, may be applied to a tick value that has been calculated for a prior or subsequent data record. The offsets and the price values to which the offsets may be applied may be separated by a number of data records or may be adjacent data records. The volume level of a data record may be determined by applying the volume level offsets to the calculated volume level of a prior or subsequent data record, starting with the base record for example.

At block 812, the computing device may apply a trading strategy to the modified dataset. The trading strategy may utilize the modified dataset to backtest the trading strategy against simulated market data that is based on the actual market data. For example, the simulated market data may be used to backtest a trading strategy for spread trading. The simulated market data in the modified dataset may be used to backtest different spreads or spreading ratios for different tradeable objects to be traded on the actual market. The computing device may apply the trading strategy using the modified dataset and may output a result of the trading strategy. For example, the computing device may generate and/or display the result of the trading strategy to a user. The result may indicate gains or losses that may be incurred by a trader when the trading strategy may be applied. The trading strategy may be applied to the modified dataset multiple times and/or to multiple modified datasets to get different results. The result that is generated and/or displayed by the computing device may be based on the trading strategy being applied multiple times. For example, the result may indicate the average gains or losses that may result from the trading strategy being applied to the modified datasets.

The output of a trading strategy may be analyzed at block 810. The definition of the trading strategy may be modified based on the output of the trading strategy. The output may be analyzed by a computing device that may automatically recommend an adjustment of the trading strategy to a user or automatically adjust the trading strategy. The output may be displayed to a user that may adjust the trading strategy on the computing device. The adjustments that may be made may include adjustments to the spreads or spreading ratios for different tradeable objects that may be traded on the actual market.

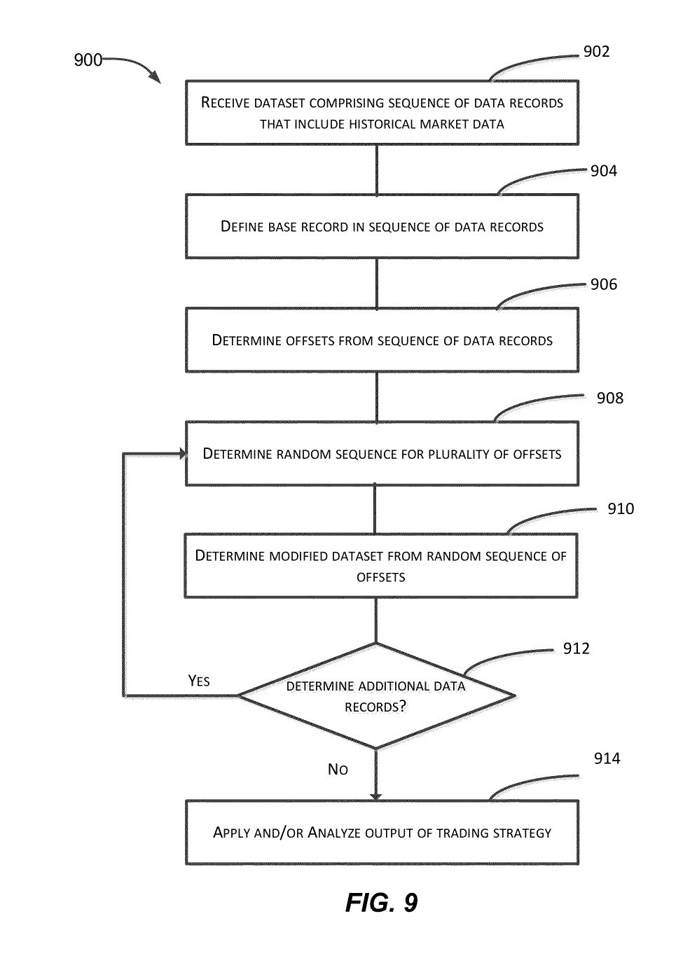

FIG. 9 is a flow diagram of an example method 900 for generating one or more modified datasets from an original dataset. The method 900 may be performed by one or more computing devices, such as trading device 210 in FIG. 2, for example. As illustrated in FIG. 9, a computing device may receive a dataset comprising a sequence of data records at block 902. The dataset, as described herein, may include market data representative of a market for at least one previously traded object offered at an electronic exchange. The market may be a real or synthetic market. The data records may comprise bar data or tick data. At block 904, the computing device may define a base record in the sequence of data records. The computing device may determine one or more offsets for the sequence of data records at block 906 (e.g., as described with respect to FIG. 6). At block 908, the computing device may determine a random sequence for the one or more offsets calculated at block 906 and may include the random sequence of the datasets in a reordered dataset with the base record. At block 910, the computing device may determine a modified dataset based on the base record and the one or more offsets calculated at block 906. The modified dataset may be computed by applying the offsets to previous or subsequent data records (e.g., as described with respect to FIG. 7B). The modified dataset may include simulated market data for the one or more markets from which the actual market data was received.

At block 912, the computing device may decide whether to determine additional data records from the actual market data received at block 902. The additional data records may be determined at block 912 for the same modified dataset to generate a greater modified dataset based on the actual market data or to generate different modified datasets for backtesting a trading strategy. For example, the computing device may prompt a user to indicate whether the user would like to generate additional data records or modified datasets from the actual market data received at block 902. Additionally, or alternatively, the computing device may determine at block 912 whether the number of data records or modified datasets that have been generated is equal to or exceeds a predefined number to be generated. If the computing device determines that additional data records or modified datasets should be determined at block 912, the method 900 may return to block 908 to generate another random sequence of offsets from the market data received at block 902. If the computing device determines at block 912 not to generate additional data records or modified datasets, the method 900 may continue to block 914 to apply a trading strategy to the one or more modified datasets that have been generated and/or analyze the output of the applied trading strategy.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A computing device comprising:
a processor configured to:
receive market data representative of a market for at least one tradeable object offered at one or more electronic exchanges, wherein the market data comprises a plurality of data records in a dataset;
define a base record from the plurality of data records;
determine at least one offset between a first data record of the plurality of data records and a second data record of the plurality of data records;
determine a modified dataset, wherein the modified dataset includes the base record and a plurality of modified data records that include simulated market data, and wherein at least one modified data record of the plurality of modified data records is based on the at least one offset determined from the first data record and the second data record of the plurality of records in the dataset; and
analyze an output of a trading strategy in response to the plurality of modified data records of the modified dataset.

2. The computing device of claim 1, wherein the at least one offset comprises a plurality of offsets.

3. The computing device of claim 1, wherein the second data record of the plurality of data records is subsequent to the first data record of the plurality of data records.

4. The computing device of claim 3, wherein the at least one offset is based on a fixed relationship between the second data record and the first data record.

5. The computing device of claim 1, wherein the processor is configured to determine the modified dataset based on a randomized set of offsets between data records in the dataset, and wherein the randomized set of offsets includes the at least one offset.

6. The computing device of claim 1, wherein the processor is configured to:
determine additional data records for the modified dataset based on the base record and additional offsets, and wherein each additional data record of the modified dataset is determined based on at least one offset of the additional offsets.

7. The computing device of claim 1, wherein the market is a real market or a synthetic market.

8. The computing device of claim 1, wherein the one or more electronic exchanges comprise a plurality of electronic exchanges.

9. The computing device of claim 1, wherein the base record is a first record or a last record of the plurality of data records in the dataset.

10. The computing device of claim 1, wherein each data record of the plurality of data records in the dataset and each modified data record of the plurality of modified data records in the modified dataset comprises bar data, wherein the bar data comprises an opening price value, a high price value, a low price value, and a closing price value, and wherein the processor is configured to determine the at least one offset between the first data record and the second data record in the dataset by determining a difference between the closing price value for the first data record in the dataset and the opening price value, the high price value, the low price value, and the closing price value for the second data record in the dataset.

11. The computing device of claim 1, wherein each data record of the dataset and each modified data record of the modified dataset comprises tick data.

12. The computing device of claim 1, wherein each data record of the dataset is associated with a volume level, and wherein the at least one offset between the first data record and the second data record includes an offset between the volume level associated with the first data record and the volume level associated with the second data record.

13. The computing device of claim 1, wherein the plurality of data records in the dataset comprise the market data for a time period, and wherein the plurality of modified data records in the modified dataset include the simulated market data for the time period.

14. The computing device of claim 1, further comprising a display, and wherein the display is configured to display at least one of the modified dataset or a chart that is based on the modified dataset.

15. The computing device of claim 1, further comprising a display, and wherein the processor is configured to:
apply the trading strategy to the modified dataset to determine the output of the trading strategy, wherein the trading strategy is associated with a tradeable object,
determine a result of the trading strategy, and
display, via the display, the result of the trading strategy.

16. A method for determining data records for backtesting a trading strategy, the method comprising:
receiving market data representative of a market for at least one tradeable object offered at one or more electronic exchanges, wherein the market data comprises a plurality of data records in a dataset;
defining a base record from the plurality of data records;
determining at least one offset between a first data record of the plurality of data records and a second data record of the plurality of data records;
determining a modified dataset, wherein the modified dataset includes the base record and a plurality of modified data records that include simulated market data, and wherein at least one modified data record of the plurality of modified data records is based on the at least one offset determined from the first data record and the second data record of the plurality of records in the dataset; and
analyzing an output of a trading strategy in response to the modified data records of the modified dataset.

17. The method of claim 16, wherein the at least one offset comprises a plurality of offsets.

18. The method of claim 16, wherein the second data record of the plurality of data records is subsequent to the first data record of the plurality of data records.

19. The method of claim 18, wherein the at least one offset is based on a fixed relationship between the second data record and the first data record.

20. The method of claim 16, wherein the modified dataset is determined based on a randomized set of offsets between data records in the dataset, and wherein the randomized set of offsets includes the at least one offset.

21. The method of claim 16, further comprising determining additional data records for the modified dataset based on the base record and additional offsets, and wherein each additional data record of the modified dataset is determined based on at least one offset of the additional offsets.

22. The method of claim 16, wherein the market is a real market or a synthetic market.

23. The method of claim 16, wherein the one or more electronic exchanges comprise a plurality of electronic exchanges.

24. The method of claim 16, wherein the base record is a first record or a last record of the plurality of data records in the dataset.

25. The method of claim 16, wherein each data record of the plurality of data records in the dataset and each modified data record of the plurality of modified data records in the modified dataset comprises bar data, wherein the bar data for the plurality of data records comprises an opening price value, a high price value, a low price value, and a closing price value, and wherein the method further comprises determining the at least one offset between the first data record and the second data record in the dataset by determining a difference between the closing price value for the first data record in the dataset and the opening price value, the high price value, the low price value, and the closing price value for the second data record in the dataset.

26. The method of claim 16, wherein each data record of the dataset and each modified data record of the modified dataset comprises tick data.

27. The method of claim 16, wherein each data record of the dataset is associated with a volume level, and wherein the at least one offset between the first data record and the second data record includes an offset between the volume level associated with the first data record and the volume level associated with the second data record.

28. The method of claim 16, wherein the plurality of data records in the dataset comprise the market data for a time period, and wherein the plurality of modified data records in the modified dataset include the simulated market data for the time period.

29. The method of claim 16, further comprising displaying at least one of the modified dataset or a chart that is based on the modified dataset.

30. The method of claim 16, further comprising:
applying the trading strategy to the modified dataset to determine the output of the trading strategy, wherein the trading strategy is associated with a tradeable object;
determining a result of the trading strategy; and
displaying the result of the trading strategy.
